(19) United States
(12) Patent Application Publication
(10) Pub. No.: US 2026/0220699 A1
(43) Pub. Date: Jul. 30, 2026

(54) A SMART RENTAL SYSTEM AND METHOD

(71) Applicant: BORUSAN MAKINA VE GUC SISTEMLERI SANAYI VE TICARET ANONIM SIRKETI, Istanbul (TR)

(72) Inventors: Esra AKCA, Istanbul (TR); Yasin DINC, Istanbul (TR); Nermin YALCI, Istanbul (TR)

(73) Assignee: BORUSAN MAKINA VE GUC SISTEMLERI SANAYI VE TICARET ANONIM SIRKETI, Istanbul (TR)

(21) Appl. No.: 19/145,199

(22) PCT Filed: Dec. 25, 2023
(86) PCT No.: PCT/TR2023/051678

§ 371 Date: Jul. 2, 2025

(30) Foreign Application Priority Data
Jan. 2, 2023 (TR) 2023/000023

(51) Int. Cl. G06Q 30/0645

(52) U.S. Cl. CPC G06Q 30/0645

(57) ABSTRACT

The invention relates to a method (200) and a system (100) operating according to the method (200), which enables the optimization of smart rental processes with artificial intelligence models, and which allows manual processes to be based on person-independent algorithms and to be monitored in a versatile and digital manner.

### TECHNICAL FIELD

The invention, especially in the construction machinery sector, relates to a smart rental system and a method of operating using the said system, which allows manual processes to be monitored digitally and in a multidimensional manner by basing them on person-independent algorithms and optimizing them with artificial intelligence models.

### STATE OF THE ART

The construction equipment rental sector was valued at 103 billion USD in 2020 and is expected to reach 137 billion USD by 2026. As construction activities were halted for a period to contain the COVID-19 pandemic, the demand for the construction equipment rental market globally was also affected. However, with the gradual opening of the economy, demand in the construction equipment rental sector has started to gain momentum. The construction industry is highly dynamic and numerous factors such as the overall economy, budgets and global economic crises affect the growth of the market. These fluctuations affect construction equipment manufacturers as well as companies operating in the construction rental sector. Therefore, the rental model is expected to become more prevalent around the world as a preferred option for construction companies to reduce or minimize the impact of unexpected financial downturns.

Currently, the operational processes required for the aforementioned rental models are carried out manually with Excel spreadsheets and/or the opinion of staff with business knowledge. This leads to errors over time, disruption of the operational process and failure to determine the optimum level.

In known rental models, product/model stocks are not kept for rental or unaccounted stocks are made. This situation causes customers to wait for the appropriate product/model during the rental process and causes time losses.

Some of the solutions developed to address the problems mentioned above are described below.

In the patent No. CN114511219A, a smart construction-machinery equipment management system based on big data, comprising at least one interconnected construction-machinery equipment, at least one mobile terminal, and a system server for managing construction-machinery equipment, and an implementation method thereof are described. Various equipment information is collected on the equipment to be analyzed by the system server and the terminal equipment for display; the mobile terminal is wirelessly connected to the system server, provides various lists, and manages construction machinery equipment.

Unlike the document in question, in our invention, topics such as prediction rental, contract management, fleet management, and picking/order planning can be calculated through machine learning of the data coming from the server and the ERP system.

In the patent No. CN112365306A, an intelligent sales management system based on an engineering machinery equipment rental method is described. The system comprises a customer management module, an engineering management module, a business opportunity management module, an order management module and a price management module. The customer management module is used to store customers'basic data; the engineering management module is used to transmit engineering information to sales staff; the business opportunity management module is used to transmit customers'basic data to vendors; the order management module is used to manage the whole process of customer transaction, and the price management module is used for pricing in combination with customer's basic data and engineering information.

Unlike the document in question, in our invention, pricing is based on artificial intelligence. Data, including external sites, are collected and an optimal price is tried to be obtained through this data. In addition to pricing, the age, working hours and models of the existing machines are taken into consideration to determine the machines to be disposed of and the machines to be purchased.

In the patent No. US2022172279 (A1), relates to a construction equipment rental system that connects construction equipment providers and construction equipment renters through a communication network. The construction equipment rental system includes a server having an accessible memory containing records of a plurality of construction equipment items offered for rental by providers, a record of at least one provider, and records of a plurality of renters. The system further includes a booking engine component configured to receive user-entered data from a renter, access the records in the memory, present the renter with an editable compact booking form for the required item, monitor data entry into the compact booking form, and expand one or more of the collapsed sections to receive other user-entered data in response to data entry by the construction equipment renter.

In our invention, unlike the smart rental system of construction equipment, simulation tests are performed, which enables demand/model/price/date range optimization. Thus, it is possible to recommend the model of work machine that suits the user's needs, and the appropriate date range and price for the appropriate model.

Although there are studies on fleet management and price optimization in the literature, there is no similar study for the desired solutions for rental companies.

In its current state, digital solutions for renting construction equipment somehow require human intervention/decision-making at every step of the system, which is insufficient and leads to errors over time, disruption of the operational process and failure to determine the optimum level. New methods need to be developed to overcome these disadvantages.

### OBJECTIVES AND BRIEF DESCRIPTION OF THE INVENTION

The main purpose of the invention is to obtain a construction equipment rental system that does not require any manual intervention in any way, which is removed from personal decisions, and a rental method that works by means of prediction algorithms.

In addition, customers receive the optimum price for construction equipment rental transactions based on the results of an impersonal artificial intelligence algorithm. Thus, pricing is made away from personal perceptions.

Another aim of the invention is to develop rental estimation models with Time series, ARIMA, SARIMAX and LSTM models, to provide an optimization using these models, thus providing cost and labor advantage.

The invention enables shaping the stocks according to the model output determined by the user and offering the most suitable product/model stock to the users. In addition, by pricing on a customer basis, it is possible to increase both customer satisfaction and profitability.

In order to accomplish the above objectives, the invention is a smart rental system that allows the smart rental processes of construction machinery to be monitored, and it comprises
at least one computing device from which data entry is made,
at least one ERP system containing invoice data,
at least one data warehouse where the data received from the computing device and the data received from the ERP system are processed,
at least one phyton server containing various data,
at least one learning component located in another server that enables the selection of the appropriate algorithm for the data coming from the data warehouse and the phyton server,
at least one estimation component located on the server and enabling the algorithm selected by the said learning component to be run,
at least one estimated result range reflecting the results from the estimation component.

The smart rental system also comprising,
at least one cloud server where the results of the estimation component are calculated in line with the tolerances of the relevant business units, and
at least one net result reflecting the results calculated by the cloud server.

In a preferred embodiment of the invention, the smart rental system comprises
at least one simulation platform that allows users to test different parameters of the calculated results or the results from the estimation component within the cloud server, and
at least one simulation result reflecting the results calculated by the simulation platform.

The invention is also a smart rental method that allows tracking smart renting processes of construction equipment, and it comprises the steps of
recording data received by means of at least one computing device into the ERP system and storing them in the data warehouse, wherein the computing device comprises an internet platform, it allows the entry of fleet information, and allows the status of the fleet to be monitored,
integration of the data warehouse with the server where estimation algorithms will be developed using methods such as machine learning (Multivariable, LSTM, etc.) and artificial neural networks,
receiving data other than fleet information via Phyton server; wherein the data are economic-leading indicators, opportunity search on the web, EUR/TRY parity, funnel management of the CRM system, machine working hours, rental agreements, documents, rental start and end dates, receivables, entry-exit order planning, campaign planning, support tracking processes, rental fleet and inspection data,
bringing the data received through the Python server into a format suitable for modeling using statistical data conversion methods with the results of regular detailed analysis in the ERP system,
sending the appropriately formatted data to the server,
calculation of the details of the main headings of prediction rental, contract management, fleet management, and total order planner by using machine learning methods on the server,
selecting the appropriate algorithm for the data through the learning component by using machine learning methods,
running and applying the selected algorithm in the estimation component and obtaining the estimated result range.

This smart rental method also comprises the process step of sharing the estimated result range with the relevant units.

This smart rental method preferably comprises the step of analyzing the estimated result range through a cloud server to obtain a net result.

In a preferred embodiment, for allowing the user to simulate the calculation performed by the cloud server or the estimation component for different parameters, the smart rental method comprises the steps of
sending the calculation performed by the cloud server or the estimation component to the simulation platform,
testing the calculation on the simulation platform based on the performance criteria predetermined by the business units, and obtaining simulation results.

The smart rental method additionally comprises the step of sharing the obtained simulation results with the relevant units.

### BRIEF DESCRIPTION OF THE FIGURES

FIG. 1, views the system components of the system subject to the invention and the relationship between them.

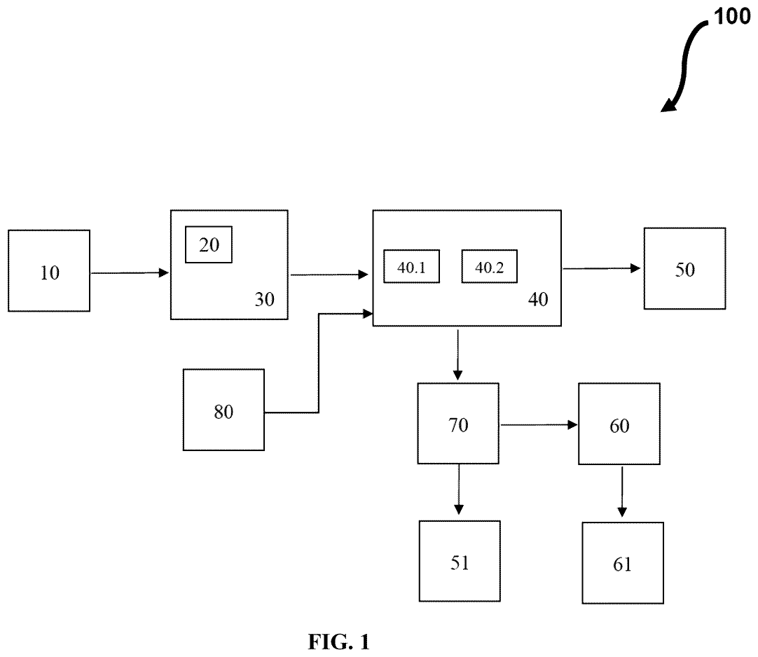

FIG. 2, views a flow diagram showing the process steps of the method subject to the invention.

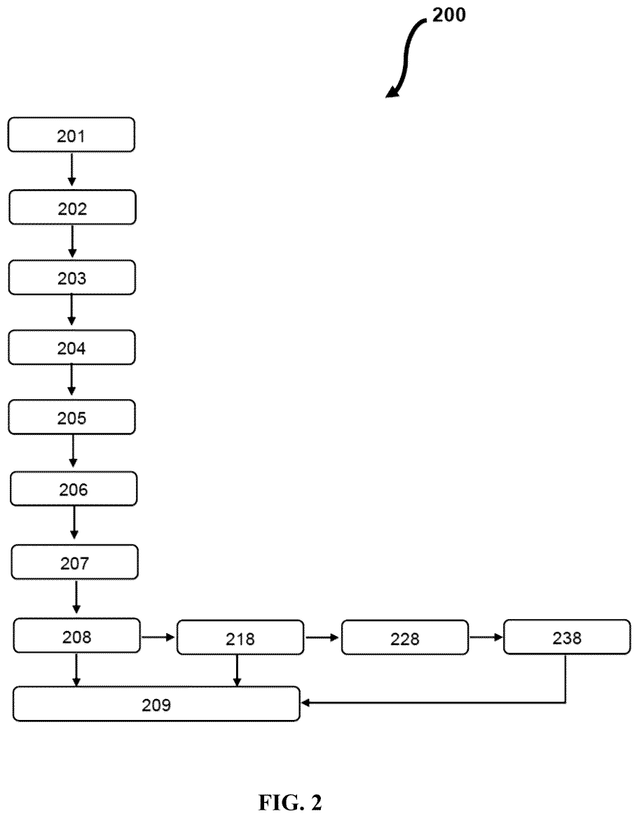

### REFERENCE NUMBERS

100. System
10. Computing device
20. ERP system
30. Data warehouse
40. Server
40.1 Learning component
40.2 Estimation component
50. Estimated result range
51. Net result
60. Simulation platform
61. Simulation result
70. Cloud server
80. Python server
200. Method
201. Recording the data received through the computing device to the ERP system and storing them in the data warehouse
202. Integration of the data warehouse with the server where the estimation algorithms will be developed
203. Receiving predefined data via phyton server
204. Bringing the data received through the Phyton server into a format suitable for modeling using statistical data conversion methods
205. Sending the appropriately formatted data to the server
206. Calculating the details of estimated rental, contract management, fleet
management, total order planner main headings
207. Selecting the appropriate algorithm for the data through the learning component
208. Execution and application of the selected algorithm by the estimation component to obtain the range of predicted results
209. Sharing the obtained estimated result range with the relevant units
218. Analyzing the estimated result range through the cloud server and obtaining a net result
228. Sending the net results to the simulation platform
238. Testing the net results on the simulation platform based on performance criteria predetermined with the business units, and obtaining the test results

### DETAILED DESCRIPTION OF THE INVENTION

The invention relates to a smart rental system (100) and a method (200) for operating using the said system (100), which allows manual processes, especially in the construction equipment sector, to be monitored digitally and in a multidimensional manner based on person-independent algorithms and optimized with artificial intelligence models.

The current invention consists of 4 main parts.

Estimation Rental: Leading indicators, opportunity search on the web, EUR/TRY Parity, funnel management of the CRM system, predicting the estimated rental using artificial intelligence algorithms using machine working hours.

Contract Management: Optimization (target profitability) of rental contracts in line with estimations and constraints. Preparing the best contract with maximum profitability calculations by changing the constraints with the interface to be prepared for the user. Linear and non-linear optimization techniques are used at this point.

Fleet Management: Automation is done with the tool. Developments are made for post-rental approvals and reporting.

Order Planner: With the tool, based on all these outputs, it is planned how much of which product the company should order.

In the estimated rental process, estimation models are developed using the SAS program architecture infrastructure, which will be created by collecting economic variables, fleet sector parameters, weather forecasts, data of competitor companies and other variables that will affect the rental estimations for the rental of construction equipment. In terms of content; estimations in 5 different segments on the basis of mining, marble, infrastructure (dams, roads, etc.), general construction (small projects, houses, etc.), public (maintenance of municipalities, etc.) sectors are realized, and modeling the sales/rental estimations of the existing machines depending on the variables in these sectors are made. Optimization and estimation models are developed to determine the machines to be disposed of and the machines to be purchased by taking into consideration the age, working hours and models of the existing machines, and taking into account the rental and sales demands from customers. For this purpose, economic indicators representing rental amounts are created. It can also be called sector-based growth estimation. Before sector-based growth estimation, correlations of variables are evaluated and estimations are made with determinant variables. Thanks to this estimation, rental amounts and macroeconomic changes can be predicted in parallel. In the ongoing process;

First, data cleaning and manipulation are performed to determine the methodologies and algorithms. Various decision trees and machine learning algorithms are tested by the researchers in line with the analysis and the most appropriate methodology is determined. The selected appropriate model is evaluated and if deemed necessary, the process is run again, starting with data cleaning.

After determining the methodology and algorithm, the development phase begins. At this stage, which starts with the installation of the development environment, the preparation/creation of tables, and the development of the determined algorithms and interfaces are carried out.

Following the aforementioned developments, unit tests and user tests are carried out, training documents are created according to the results of these tests, and user manuals are prepared and transferred to the rental unit personnel.

Rental unit personnel use the relevant business process objectives in the 4 main sections mentioned above.

The system (100) used in the estimation method described above comprising
at least one computing device (10) from which data entry is made,
at least one ERP system (20) containing invoice data,
at least one data warehouse (30) where the data received from the said computing device (10) and the data received from the said ERP system (20) are processed,
at least one phyton server (80) containing various data,
at least one learning component (40.1) located in a server (40) that enables the selection of the appropriate algorithm for the data coming from the mentioned data warehouse (30) and the phyton server (80),
at least one estimation component (40.2) located on the server (40) and enabling the algorithm selected by the said learning component (40.1) to be run,
at least one estimated result range (50) reflecting the results from the mentioned estimation component (40.2).

The computing device (10) refers to a computer hardware for entering fleet information and an internet platform that can monitor the status of the fleet within this hardware.

The ERP system (20) contains the financial and accounting data (e.g. invoices) of the rental transactions.

The data warehouse (30) uses machine learning (Multivariable, LSTM, etc.) and artificial neural networks to process the data stored in it.

By various data in the phyton server (80); leading indicators, opportunity search on the web, EUR/TRY parity, funnel management of the CRM system, machine operating hours, rental contracts, documents, rental start and end dates, receivables, rental fleet and inspection data are meant. These data are stored by the phyton server (80) and transferred to the server (40).

The server (40) transfers the data from the data warehouse (30) and phyton server (80) to the learning component (40.1) it has.

The learning component (40.1) selects the appropriate algorithm for the data using machine learning methods. The estimation component (40.2) runs the algorithm selected by the learning component (40.1) and calculates the estimated result range (50).

In preferred embodiment, the invention also comprising
at least one cloud server (70) where the results of the estimation component (40.2) are calculated in line with the tolerances of the relevant business units,
at least one net result (51) reflecting the results calculated by the cloud server (70).

When it is needed to calculate the net result (51) with certainty instead of the estimated result range (50), the aforementioned cloud server (70) is used. The cloud server (70) calculates the net result (51) by re-evaluating the estimated result range (50) received from the estimation component (40.2) in line with various tolerances such as the model of the work machine of the relevant business units, the size of the fleet to be rented and the rental dates.

The above-mentioned parameters may vary according to the sector and the way of working of the users who will use the system.

The invention may optionally also comprising:
at least one simulation platform (60) that allows users to test different parameters of the calculated results within the mentioned cloud server (70) or the results from the estimation component (40.2), and
at least one simulation result (61) reflecting the results calculated by the simulation platform (60)

The input data (parameters) used to generate the economic indicators in the simulation platform (60) are given below. By varying these parameters, it is possible to predict which results will occur in different situations.
Euro
Overnight Interest Rate
Unemployment rate
Consumer confidence index
Gross domestic product (GDP) construction thousand TL level
Producer price index (PPI) annual change

While the learning component (40.1) in the server (40) performs learning from its own errors, continuous improvement processes are carried out in the system (100) by ensuring that the estimation component (40.2) processes the data instantaneously and transfers the data to the data warehouse (30) and the ERP system (20).

In order to obtain the prediction result range (50) using the inventive method (200), the following steps are applied;
recording data received by means of at least one computing device (10) into the ERP system (20) and storing them in the data warehouse (30), wherein the computing device comprises an internet platform, it allows the entry of fleet information, and allows the status of the fleet to be monitored (201),
integration of the data warehouse (30) with the server (40) where estimation algorithms will be developed using methods such as machine learning (Multivariable, LSTM, etc.) and artificial neural networks (202),
receiving data other than fleet information via Phyton server; wherein the data are economic-leading indicators, opportunity search on the web, EUR/TRY parity, funnel management of the CRM system, machine working hours, rental agreements, documents, rental start and end dates, receivables, entry-exit order planning, campaign planning, support tracking processes, rental fleet and inspection data (203),
bringing the data received through the Python server into a format suitable for modeling using statistical data conversion methods with the results of regular detailed analysis in the ERP system (20) (204),
sending the appropriately formatted data to the server (40) (205),
calculation of details of the main headings of estimated rental, contract management, fleet management, and total order planner by using machine learning methods on the server (40) (206),
selecting the appropriate algorithm for the data through the learning component (40.1) by using machine learning methods (207),
running and applying the selected algorithm in the estimation component (40.2) and obtaining the estimated result range (50) (208), and preferably
sharing the estimated result range (50) with the relevant units (209).

In the inventive method, it is alternatively possible to analyze the estimated result range (50) by means of the cloud server (70) to obtain the net result (51) (218).

In some cases, the user may need to simulate the calculation performed by the cloud server (70) or the estimation component (40.2) for different parameters. In particular, there may be a need to estimate how the results may change for different economic parameters (e.g. if the dollar exchange rate is 25 TL). In order for the inventive method to meet this need, the following alternative steps can be implemented;
sending the calculation performed by the cloud server (70) or the estimation component (40.2) to the simulation platform (60) (228),
testing the calculation on the simulation platform (60) based on the performance criteria predetermined by the business units, and obtaining simulation results (61) (238), and preferably
sharing the simulation results (61) with the relevant units (209).

In step 202, parameters such as the EUR exchange rate, overnight interest rate, unemployment rate, consumer confidence, GDP construction and the PPI (producer price index) are used to construct economic-leading indicators. Two sub-indicators, a short-term indicator and a long-term indicator, are created by taking these parameters into account. These indicators are combined to form an economic indicator. The collected input data is estimated for a period of 12 months. Estimation is performed for these economic indicators using the Vector Error Correction (VEC) model and Neural Prophet artificial intelligence models.

What is claimed is:

1. A smart rental system (100) that allows tracking of smart rental processes of construction equipment characterized by comprising
at least one computing device (10) from which data entry is made,
at least one ERP system (20) containing invoice data,
at least one data warehouse (30) where the data received from the computing device (10) and the data received from the ERP system (20) are processed,
at least one phyton server (80) containing various data,
at least one learning component (40.1) located in another server (40) that enables the selection of the appropriate algorithm for the data coming from the data warehouse (30) and the phyton server (80),
at least one estimation component (40.2) located on the server (40) and enabling the algorithm selected by the learning component (40.1) to be run,
at least one estimated result range (50) reflecting the results from the estimation component (40.2).

2. A smart rental system (100) according to claim 1, wherein it comprises
at least one cloud server (70) where the results of the estimation component (40.2) are calculated in line with the tolerances of the relevant business units, and
at least one net result (51) reflecting the results calculated by the cloud server (70).

3. A smart rental system (100) according to claim 1, wherein it comprises
at least one simulation platform (60) that allows users to test different parameters of the calculated results within the cloud server (70) or the results from the estimation component (40.2), and
at least one simulation result (61) reflecting the results calculated by the simulation platform (60).

4. A smart rental method (200) that allows tracking the smart rental processes of construction equipment characterized by comprising
recording data received by means of at least one computing device (10) into the ERP system (20) and storing them in the data warehouse (30), wherein the computing device comprises an internet platform, it allows the entry of fleet information, and allows the status of the fleet to be monitored (201),
integration of the data warehouse (30) with the server (40) where estimation algorithms will be developed using methods such as machine learning (Multivariable, LSTM, etc.) and artificial neural networks (202),
receiving data other than fleet information via Phyton server (80); wherein the data are economic-leading indicators, opportunity search on the web, EUR/TRY parity, funnel management of the CRM system, machine working hours, rental agreements, documents, rental start and end dates, receivables, entry-exit order planning, campaign planning, support tracking processes, rental fleet and inspection data (203),
bringing the data received through the Python server (80) into a format suitable for modeling using statistical data conversion methods with the results of regular detailed analysis in the ERP system (20) (204),
sending the appropriately formatted data to the server (40) (205),
calculation of details of the main headings of prediction rental, contract management, fleet management, and total order planner by using machine learning methods on the server (40) (206),
selecting the appropriate algorithm for the data through the learning component (40.1) by using machine learning methods (207),
running and applying the selected algorithm in the estimation component (40.2) and obtaining the estimated result range (50) (208).

5. A smart rental method (200) according to claim 4, wherein it comprises the step of sharing the prediction result range (50) with the relevant units (209).

6. A smart rental method (200) according to claim 4, wherein it comprises the step of analyzing the estimated result range (50) through the cloud server (70) to obtain the net result (51) (218).

7. A smart rental method (200) according to claim 4, wherein it comprises the steps of
sending the calculation performed by the cloud server (70) or the estimation component (40.2) to the simulation platform (60) (228),
testing the calculation on the simulation platform (60) based on the performance criteria predetermined by the business units, and obtaining simulation results (61) (238) to allow the user to simulate the calculation performed by the cloud server (70) or the estimation component (40.2) for different parameters.

8. A smart rental method (200) according to claim 7, wherein it comprises the step of sharing the obtained simulation results (61) with the relevant units (209).
